(19) United States
(12) Patent Application Publication
(10) Pub. No.: US 2004/0102242 A1
(43) Pub. Date: May 27, 2004

(54) Systems and methods for establishing a verifiable random number

(76) Inventor: Boudewijn Johannes Maria Poelmann, Amsterdam (NL)

Correspondence Address: Gerson S. Panitch, Finnegan, Henderson, Farabow,, Garrett & Dunner, L.L.P., 1300 I Street, N.W., Washington, DC, 20005-3315, US

(21) Appl. No.: 10/437,992

(22) Filed: May 15, 2003

Related U.S. Application Data
(60) Provisional application No. 60/428,427, filed on Nov. 21, 2002.

(51) Int. Cl. G06F 17/00

(52) U.S. Cl. 463/22

(57) ABSTRACT

A method is disclosed for establishing a verifiable random number for use in a process that involves a random number. A source for a seed number is selected, the source being publicly available and publicly accepted as a source for numbers that are random. An algorithm is established that uses the seed number as a basis for determining the verifiable random number. The random number is then generated using the seed number and the algorithm. The source of the seed number and the algorithm are preferably published in advance of an existence of the seed number to enable at least one individual to reproduce a calculation of the random number.

### RELATED APPLICATION

Under provisions of 35 U.S.C. § 119(e), Applicant claims the benefit of U.S. provisional patent application entitled SYSTEMS AND METHODS FOR ESTABLISHING A VERIFIABLE RANDOM NUMBER, filed Nov. 21, 2002, Application Serial No. 60/428,427, which is incorporated herein by reference.

### TECHNICAL FIELD

The present invention relates to methods and systems that employ random numbers. For example, the invention may be used in connection with games of chance, such as lotteries.

### BACKGROUND

Games of chance date back to antiquity. Dice were recovered from Egyptian tombs, while the Chinese, Japanese, Greeks, and Romans all were known to play games of skill and chance for amusement as early as 2300 B.C. Lotteries, derived from “lotto”, the Italian word for destiny or fate, can at least be traced back to the Bible. Chapter 26 of the book of Numbers describes Moses using a lottery to award tracts of land west of the River Jordan. It is also said that the construction of the Great Wall of China was financed by funds raised by lotteries, and that certain lottery forms date back to the time of Julius Caesar.

Lotteries flourished throughout Europe between the 15th and 17th centuries. In 1498, Portugal instituted a lottery to raise funds to help the underprivileged and to meet other monetary needs. Lotaria Nacional Santa Casa da Misericórdia de Lisboa, one of the world's oldest continuously operating lotteries, was authorized in 1783 by Queen D. Maria Pia. Similar to the Portuguese lottery, in 1727 the Netherlands formed another of the world's oldest continuous lotteries. At that time, the main purpose for creating a lottery was to replenish a country's depleted funds and to finance various civic needs.

Lotteries flourished in North America as well. After lotteries served to fund institutions like the Virginia Company, which established the first permanent settlement in 1607, and Harvard University, lotteries became more widespread and less regulated. By the 1980s, instant lottery sales in the United States surpassed $1 billion with 16 states selling instant games. Canadian lotteries, concerned that instant games may overshadow their passive games, began introducing various hybrid games.

Novamedia of the Netherlands, cooperates with local and international charities, including UNICEF, The Red Cross, Amnesty International, Greenpeace, and the World Wide Fund for Nature, to raise funds for charities by organizing lotteries.

Whether it be a lottery or any other system whose outcome relies on one or more random numbers, there is a need to ensure that such numbers are truly random, and not subject to manipulation.

In lotteries, for example, due to the remoteness of the player to the game operator, it may be important to provide players with confidence that the operator is truly operating a fair game.

### SUMMARY OF A FEW ASPECTS OF THE INVENTION

One aspect of the invention involves a method of establishing a verifiable random number for use in any type of process that may be benefit from a verifiable random number. In such a system, according to one aspect of the invention, a publicly available source for a seed number is selected. That source should be one that is publicly accepted as a source for numbers that are random. For example, a financial index, such as the Dow Jones Industrial Average, is widely recognized as a source for numbers impossible to manipulate with precision.

An algorithm is then established that uses the seed number as a basis for determining a verifiable random number. Thereafter, the random number is generated using the seed number and the algorithm. So that the randomness may be independently verified by the interested public, the source of the seed number and the algorithm are preferably published in advance of an existence of the seed number to enable reproduction of the random number calculation.

So, for example, participants in a lottery may be provided with an algorithm that accepts a variable (i.e., the seed number). Participants may be told that the winning lottery number will be calculated using the algorithm, with variable being the Dow Jones Industrial Average at the close of business on a particular date. In this way, participants may calculate the winning number on their own, and in the process independently verify the randomness of the winning number. This provides confidence in the game, and hence the likelihood of increased participation.

The invention involves various methods and systems. Thus, the foregoing general description and the following detailed description are exemplary only, with the invention being defined by the appended claims and their equivalents.

### BRIEF DESCRIPTION OF THE DRAWINGS

The accompanying drawings provide a further understanding of the invention and, together with the detailed description, explain principles of the invention. In the drawings:

FIG. 1 is a flow chart of an exemplary method for establishing a verifiable random number consistent with an embodiment of the present invention;

FIG. 2 is a flow chart of an exemplary algorithm that uses a seed number as a basis for determining a verifiable random number consistent with an embodiment of the present invention; and

FIG. 3 is a functional block diagram of an exemplary system for establishing a verifiable random number consistent with an embodiment of the present invention.

### DESCRIPTION OF VARIOUS EMBODIMENTS

Reference will now be made to various embodiments consistent with the invention, examples of which are shown in the accompanying drawings.

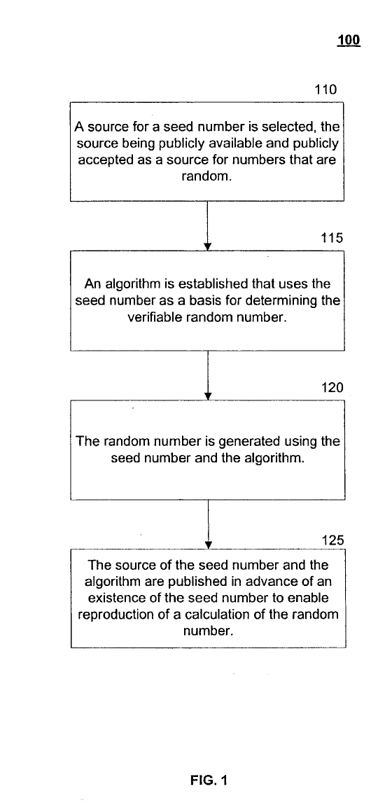

As previously mentioned, embodiments of the invention relate to methods and systems for generating random numbers that may be independently verified as being free from manipulation. FIG. 1 provides one such example in the form of method stages 100. While this description uses lotteries and other games of chance as a medium for describing aspects of the invention, in its broadest sense, the invention is not so limited. The invention may certainly be used in games of chance such as bingo, lotteries, or other gambling type activities. But it may also be used in processes including data encryption or data communications. Indeed, the invention may be practiced in connection with any process where verification of a random number may be desirable.

Exemplary method 100 may begin with stage 110 where a source for a seed number is selected, the source being publicly available and publicly accepted as a source for numbers that are random. The term “publicly available” means that the source is available to an interested group. For example, if the “interested group” is the general public, then the seed source may be made available to the general public through publications such as newspapers or other widely available media (hard or electronic). For example, the seed source might be the Dow Jones Industrial Average (DJIA), a source that is widely published and accepted as a source for numbers effectively impossible to manipulate with precision. The “publicly available” source does not necessarily require any particular demographic publication. For example, number sources within certain industries or among certain subgroups of the population may be accepted within those subsegments as being sources of random numbers. If the invention is used with a process specific to one such group, the source of random numbers may not be published beyond that group, but it is still considered publicly available in the context of the invention.

In addition, “publicly available” does not necessarily require that the source appear in any particular type of publication. It may be printed in common newspapers, broadcast on conventional radio, television, satellite, or internet, or it may appear in any non-conventional media. Thus, in the broadest sense, “publicly available” simply requires that interested third parties have a way of independently verifying the random nature of an outcome, through some independent source. Of course, the source is preferably free of any specific pattern and provide no one with an advantage not available to others in determining the value of a random element before it is produced by the source. In addition, the random nature of the source ensures that the entity generating the random element has no control over determination of the random number.

The source of the seed number may be a financial index such as one or more of the DJIA, AMEX, S&P 500, a commodities price, or a futures index. If the process employing the random number is a periodic lottery and the seed source is the DJIA, the seed number may be the DJIA at the close of trading on the pre-announced day of the lottery drawing.

The aforementioned financial indices are exemplary of seed sources and other financial indices may be used. Moreover, the source for the seed number need not be financially related. Rather, it also include one or more sporting events, political events, entertainment events, or any other source of a random seed number in which an interested group may have confidence. For example, the total scores of one or more sporting events on a given day or the number of votes cast in a political election may be numbers that at least certain groups of the public may have confidence are free from precise manipulation. Regardless of the source, the seed “number” need not be limited numeric elements. Thus, as used throughout, the term “number” generically refers to any element, be it numeric, alphanumeric, or non-numeric.

In addition, as used herein, a number is random if at least a portion of it may not be precisely controlled or predicted. Thus, even though the first few digits of the DJIA may be predicted on any given day, the final digits may not. As a result, the DJIA falls with the broad definition of “random,” as used herein.

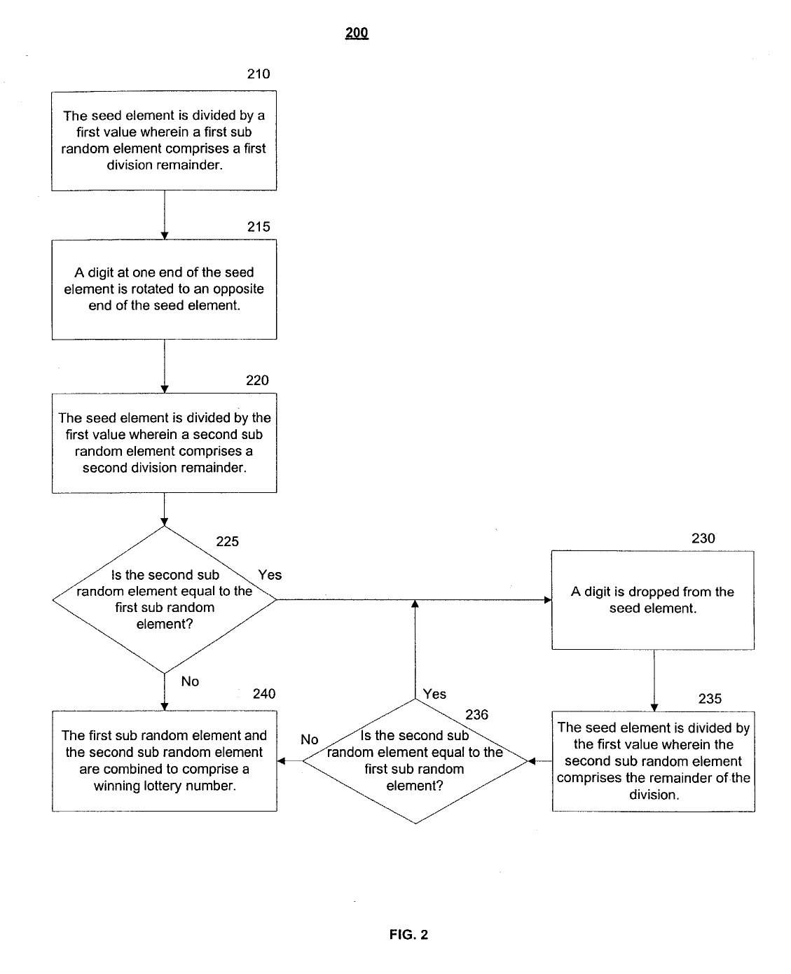

After the source for the seed number is selected at stage 110, exemplary method 100 continues to stage 115 where an algorithm is established that uses the seed number as a basis for determining the verifiable random number. By way of example only, the algorithm may be one such as is depicted in FIG. 2, which is described later in greater detail. Of importance is the fact that the invention, in its broadest sense, is not limited to any particular algorithm or mechanism for generating the random number from the seed. Rather, it is contemplated that an infinite number of algorithms could be used without departing from the scope or spirit of the invention. Thus, the algorithm later described in connection with FIG. 2 is presented by way of example only.

After the algorithm is established that uses the seed number as a basis for determining the verifiable random number in stage 115, exemplary method 100 advances to stage 120 where the random number is generated using the seed number and the algorithm.

The algorithm may be a series of rules as opposed to a pure mathematical calculation. For example, the algorithm might result in a three digit random number by combining the second decimal places of General Motors, Daimler Chrysler and Ford stock prices at the closing bell on a particular day. So, if GM closed at 36.32, Daimler Chrysler at 30.76 and Ford at 8.18, the random number might be 268. Using the same three stock prices as the source, the rule might alternatively be that all the digits of the three stock prices are totaled, and then the first digit move to the last place. (i.e., 3+6+3+2+3+0+7+6+8+1+8=47. Moving the first digit to the last place provides a random number of 74. Or, for example, the random number may be the last three digits of the total of all National Football League scores on a given Sunday. Alternatively, the algorithm may be a combination of one or more set of rules with one or more mathematical calculations. For example, either of the three previous numbers generated from rules might be further “randomized” through a series of predetermined mathematical calculations. Just as the number of calculations falling within the scope of the invention are infinite, so too is the logic or methodology used to reach the random number from the seed. Thus, the invention, in its broadest sense is not limited to a particular methodology.

At stage 125, the source of the seed number and the algorithm are published in advance of an existence of the seed number to enable at least one individual to reproduce a calculation of the random number. For example, prior to the establishment of the random number, an enterprise that intends to produce the random number may make available to an individual or group of individuals a process or algorithm that the enterprise intends to use to generate the random number. Specifically, a lottery enterprise may make known in advance of a drawing, an algorithm and a source of the seed number to be used in the algorithm. In doing so, individuals participating or wagering in the lottery may have confidence that the game is fair and therefore may be more likely to play the lottery. Publication of the source of the seed number and the algorithm may be accomplished using at least one of print media, audio media, audio visual media, e-mail, voice mail, facsimile, “paper” mail, an item delivery service, Internet, telephone, diskette, CD ROM, a kiosk, or an interactive voice response system (IVR). The aforementioned media for publishing the source of the seed number and the algorithm are exemplary only, and any other media may be employed in connection with the invention in its broadest sense.

It also should be noted that the stages of FIG. 1 need not occur in the order presented. For example, identification of the seed source and the algorithm in stage 125 may occur before stages 115 or 120.

As in the case of some lotteries, a winner is one who matches a series of six numbers, each often no greater than 49. Thus, the next example, presented in FIG. 2 in the form of algorithm 200, uses a single seed to generate six random numbers. It does so by relying on the remainder of a long division to further randomize a seed number, and to generate multiple random numbers from a single seed number. At stage 210 of algorithm 200, a seed number is divided by a first value to arrive at a first sub random element. Assume that the seed source is the DJIA, and it closes on a particular predetermined date at 9243.26. A first step in the algorithm might be to shift the decimal point one place to the left, resulting in the number 924.326. In division, the remainder can only be a number between zero and the divisor inclusively. Thus, the divisor should be less than or equal to the maximum value of the random number. As a result, in the exemplary algorithm, the number 49 is prechosen as a fixed first divisor.

In this example, the remainder is determined in the division once a solution containing the same number of decimal places as the number being divided is determined. Thus, when 49 is divided into 924.326, the division process is stopped when the result, 18.863, has the same number of decimal places as the number divided, 924.326. This results in a remainder of 39, as exemplified by the calculation below:

$$\begin{matrix}\underline{18.863} \\ 49 / 924.326 \\ \underline{49} \\ 434 \\ \underline{392} \\ 423 \\ \underline{ 392} \\ 312 \\ \underline{294} \\ 186 \\ \underline{147} \\ 39\end{matrix}$$

From stage 210, where the seed number is divided by the first value, exemplary method 200 continues to stage 215 where a digit at one end of the seed number is rotated to an opposite end of the seed number. Continuing the example with the original seed number of 924.326, the 6 in the rightmost position is shifted to the leftmost position, resulting in the number 692.432.

After this rotation, at stage 215, exemplary algorithm 200 advances to stage 220 where the rotated seed number is also divided by 49. For example, the result of 692.432 divided by 49 (the first value) is 14.131 with a remainder of 13. Thus 13 is the second sub random element. The same exemplary division process described above with respect to stage 210 may be employed in the stage 220 division.

In a multiple number lottery, it is not common to permit the same number to appear twice in a group of winning numbers. Yet, in mathematics, it is possible that the remainder of two different divisions will end up being the same number. As a result, the exemplary algorithm checks each newly generated remainder to determine if it equals a previous one. If a match is found, a new sub random number is generated. Thus, following stage 220, exemplary method 200 proceeds to decision block 225 to determine if the second sub random element is equal to the first sub random element. To best illustrate this point, assume that the original seed number was 874.545 (as opposed to 692.432). 874.545 divided by 49 (the first value) results in 17.847 with a remainder of 42. Thus the first sub random element is 42. Shifting the decimal and digit as described in stage 215 results in a seed number of 587.454 divided by the first value 49. This division produces 11.988 also with a remainder of 42. Thus the first sub random element and the second sub random element are equal. To avoid two identical random numbers in the same group, the later generated duplicate result is discarded at decision block 225 and exemplary method 200 continues to stage 230 where the first digit is dropped from the seed number. Thus, seed number 587.454 is revised to become 87.454.

At stage 235, the revised seed number is divided by 49 producing 1.784 with a remainder of 38. Thus the second sub random element becomes 38. The same exemplary division process described above with respect to stage 210 may be employed in the stage 235 division. The stages of exemplary method 200 may be repeated to produce as many sub random elements as are needed for the lottery or other process.

If it is determined, however, at decision block 225 (or 236) that the second sub random element is not equal to the first sub random element, the process continues as described above to arrive at a predetermined number of “subrandom elements.” Depending on the process, subrandom elements may be combined to arrive at random numbers with more than two digits. For example, if the first sub random element comprises 42 and the second sub random element comprises 38, the verifiable random element may comprise 4238.

An alternate exemplary method for establishing a verifiable random number consistent with an embodiment of the present invention may include using a seed number in a different way. For example, the digits from the first two decimal places may comprise a first sub random element. In addition, the remainder of a division of the digits to the left of the seed number's decimal point by a first value may comprise a second sub random element. Moreover, the remainder of a division of the digits to the left of the seed number's decimal point by a second value may comprise a third sub random element. The verifiable random number may comprise a combination of one or more of the sub random elements. This process may be repeated using a plurality of values in addition to the first and second values to create more sub random elements.

Consistent with the general principles of the present invention, the algorithm or other aspects of the process may be embodied in a system utilizing a microprocessor or software in order to automate the process. For example, a system of establishing a verifiable random number for use in a process that involves a random number may comprise an input for receiving a seed number from a predesignated source, the source being publicly available and publicly accepted as a source for numbers that are random, a processor for receiving the seed number from the input and for incorporating the seed number into a publicly published algorithm, the processor for generating a random number using the seed number and the algorithm, and a component for publishing the source of the seed number and the algorithm in advance of an existence of the seed number to enable reproduction of a calculation of the random number.

The input for receiving a seed number, the processor for receiving the seed number, and the component for publishing may comprise elements of, be disposed within, or may otherwise be utilized by or embodied within one or more of the following: a mobile phone, a personal computer, a hand-held computing device, a multiprocessor system, microprocessor-based or programmable consumer electronic device, a minicomputer, a mainframe computer, a personal digital assistant (PDA), a facsimile machine, a telephone, a pager, a portable computer, or any other device that may receive, transmit, and/or process information. The above devices are exemplary and the component for selecting, the component for establishing the algorithm, the component for generating, the component for publishing, the component for providing, the component for establishing the seed number, and the component for creating may comprise elements of, be disposed within, or may otherwise be utilized by or embodied within many other devices or system without departing from the scope and spirit of the invention.

Moreover, embodiments of the invention may be practiced in electrical circuits comprising discrete electronic elements, packaged or integrated electronic chips containing logic gates, circuits utilizing microprocessors, or on a single chip containing electronic elements or microprocessors. Furthermore, embodiments of the invention may be provided using other technologies capable of performing logical operations such as, for example, AND, OR, and NOT, including but not limited to mechanical, optical, fluidic, and quantum technologies. In addition, the invention may be practiced within a general purpose computer, may be implemented in software either as part of a runtime library routine or software generated by an otherwise conventional compiler, or in any other circuits or systems.

By way of example only, when the invention is used in a game of chance, a customer may place a wager. The wager may be receive, for example, by billing the individual, debiting the individual's checking account, debiting the individual's credit card account, debiting the individual's debit card account, debiting the individual's preestablished account, or receiving cash or other forms of payment from the individual. The precceding ways of receiving the wager are exemplary and other ways of receiving a wager may be employed. In additon, the wager may be received using, for example, at least one of the communication media described herein. The wager may be placed over the internet, in a retail establishment, by phone, by mail, or through any other medium of transaction

The customer may have the option of self selecting a number sequence or having a computer automatically select a number sequence, as is known in the art. Thereafter, at the pre-appointed time of a lottery drawing, for example, the winning number sequence is generated using the seed source and the pre-published algorithm. Since both are available to the customer, the customer may independently calculate the winning lottery number.

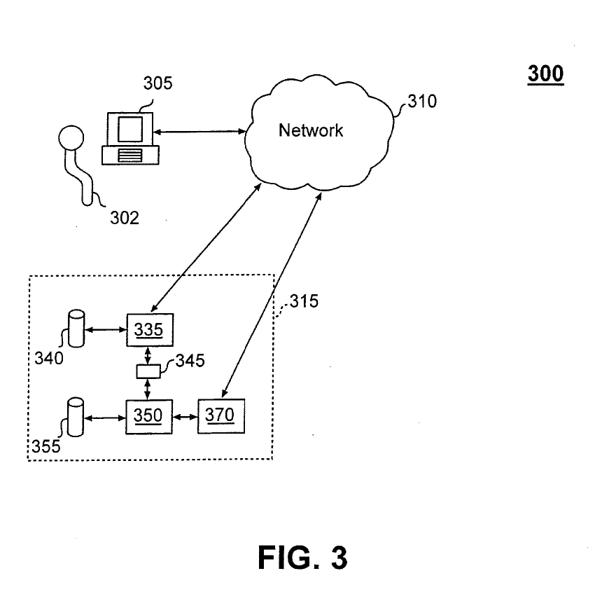

As herein embodied and illustrated in FIG. 3, a system 300 for establishing a verifiable random number for use in a process that involves a random number may comprise a user computer 305, a network 310, and a verifiable random number server 315. System 300 may be operated by, for example, an enterprise providing a lottery. In the exemplary embodiment of FIG. 3, the input for receiving a seed number, the processor for receiving the seed number, and the component for publishing may be embodied in server 315. It will be appreciated, however, that other elements of system 300 may accomplish one or more of these functions.

User computer 305, which may be operated by a lottery participant for example, may comprise a personal computer or other similar microcomputer-based workstation. It will be appreciated, however, that user computer 305 may comprise any type of computer operating environment such as hand-held devices, multiprocessor systems, microprocessor-based or programmable consumer electronics, minicomputers, mainframe computers, and the like. User computer 305 may also be practiced in distributed computing environments where tasks are performed by remote processing devices. Furthermore, user computer 305 may comprise a mobile terminal such as a smart phone, telephone, personal digital assistant (PDA), intelligent pager, portable computer, a hand held computer, or any device capable of receiving wireless data. Wireless data may include, but is not limited to, paging, text messaging, e-mail, Internet access and other specialized data applications.

User computer 305 may be located in a home, office, store, retail center kiosk, casino, grocery store, automobile fueling station, convenience store, restaurant, remote location, or any location wherein it may be operated. Individual user 302 may be a technician, a lottery participant, a government agent, or any other person or agent of a person seeking to use a process that involves a random number. For example, user computer 305 may be operated on behalf of individual 302, by an employee or agent of one of the previously described establishments. Thus, it will appreciate that within the context of this invention, user computer 305 may be located at a variety of places and operated by a variety of people.

Network 310 may comprise, for example, a local area network (LAN) or a wide area network (WAN). Such networking environments are commonplace in offices, enterprise-wide computer networks, intranets, and the Internet and are known. When a LAN is used as network 310, user computer 305 and elements of server 315 may be connected to network 310 through a network interface located at each of the respective user computer 305 and elements of server 315. When a WAN networking environment is utilized as network 310, user computer 305 and elements of server 315 typically include an internal or external modem (not shown) or other means for arranging communications over the WAN, such as the Internet.

In addition to utilizing a wire line communications system as network 310, a wireless communications system, or a combination of wire line and wireless may be utilized as network 310 in order to, for example, exchange web pages via the internet, exchange e-mails via the Internet, or for utilizing other communications media. Wireless can be defined as radio transmission via the airwaves. However, it may be appreciated that various other communication techniques can be used to provide wireless transmission including infrared line of sight, cellular, microwave, satellite, packet radio and spread spectrum radio.

Data sent over network 310 may be encrypted to insure data security. For example, if the invention is used for coded messages or other security uses, it may be necessary to transmit the algorithm securely using encryption. Or for example, when used in connection with internet or other network based applications, it may be beneficial to encrypt payment or other personal information. When encrypting, the data may be converted into a secret code for transmission over a public network. The original file, or “plaintext,” may be converted into a coded equivalent called “ciphertext” via an encryption algorithm executed, for example, on user computer 305 or on elements of server 315. The ciphertext is decoded (decrypted) at a receiving end and turned back into plaintext.

The encryption algorithm may use a key, such as a binary number key, typically from 40 to 128 bits in length. The greater the number of bits in the key (cipher strength), the more possible key combinations and the longer it would take to break the code. The data is encrypted, or “locked,” by combining the bits in the key mathematically with the data bits. At the receiving end, the key is used to “unlock” the code and restore the original data.

By way of example, two cryptographic methods that may be suitable for use with system 300 are Data Encryption Standard (DES) and Rivest-Shamir-Adleman (RSA). In DES, both sender and receiver use the same secret key to encrypt and decrypt. This is the fastest method, but transmitting the secret key to the recipient in the first place is not secure. RSA (see www.rsa.com) uses a two-part concept with both a private and a public key. The private key is kept by the owner; the public key is published. Each recipient has a private key that is kept secret and a public key that is published for everyone. The sender looks up the recipient's public key and uses it to encrypt the message. The recipient uses the private key to decrypt the message. Owners never have a need to transmit their private keys to anyone in order to have their messages decrypted, thus the private keys are not in transit and are not vulnerable.

Public key cryptography software marketed under the name Pretty Good Privacy (www.pqp.com) may be utilized in this embodiment. While PGP may be used to encrypt data transmitted over network 310, it will be appreciated that many other types of encryption algorithms, methods, and schemes may be employed.

In system 300, data may be transmitted by methods and processes other than, or in combination with network 310. These methods and processes may include, but are not limited to, transferring data via, diskette, CD ROM, facsimile, conventional mail, an interactive voice response system (IVR), or via voice over a publicly switched telephone network. An IVR is an automated telephone answering system that responds with a voice menu and allows the user to make choices and enter information via the telephone keypad. IVR systems are widely used in call centers as well as a replacement for human switchboard operators. An IVR system may also integrate database access and fax response.

Still referring to FIG. 3, server 315 may comprise a first server front end with its associated first server front end database 340, a first server back end 350 with its associated first server back end database 355, and a simple mail transfer protocol (SMTP) server 370. First server front end 335 may be separated from first server back end 350 by a first server firewall 345. One function of first server front end 335 is to provide an interface via network 310 between user computer 305 and server 315. The function of the SMTP server 370 is to provide, for example, an e-mail interface via network 310 between user computer 305 and server 315.

Simple Mail Transfer Protocol is a standard e-mail protocol on the Internet. It is a TCP/IP protocol that defines the message format and the message transfer agent (MTA), which stores and forwards the mail. SMTP was originally designed for only ASCII text, but MIME and other encoding methods enable program and multimedia files to be attached to e-mail messages. SMTP servers route SMTP messages throughout the Internet to a mail server, such as a Post Office Protocol 3 (POP3) or an Internet Messaging Access Protocol (IMAP) server, which provides a message store for incoming mail.

Post Office Protocol 3 (POP3) servers, using the SMTP messaging protocol, are standard mail servers commonly used on the Internet. POP3 servers provide a message store that holds incoming e-mail until users log on and download them. With POP3, all pending messages and attachments are downloaded at the same time. Internet Messaging Access Protocol (IMAP) is also a standard mail server that is widely used on the Internet. It provides a message store that holds incoming e-mail until users log on and download them. IMAP, however, is more sophisticated than the POP3 mail server. In IMAP, messages can be archived in folders, mailboxes can be shared, and a user can access multiple mail servers. There is also better integration with MIME, which is used to attach files. For example, users can read only the headers in the message without having to automatically accept and wait for unwanted attached files to download.

First server front end 335 and first server back end 350 may comprise a personal computer or other similar microcomputer-based workstations. It will be appreciated, however, that first server front end 335 and first server back end 350 may comprise any type of computer operating environment such as hand-held devices, multiprocessor systems, microprocessor-based or programmable consumer electronics, minicomputers, mainframe computers, and the like. By way of example only, first server front end 335 and first server back end 350 may also be practiced in distributed computing environments where tasks are performed by remote processing devices. By way of example only, first server front end 335 may be implemented on a Compaq Proliant 1600 server running Windows 2000 and Domino Webserver. First server back end 350 may be implemented on a Compaq Proliant 1600 server running NT4 and Domino Application Server. And SMTP server 370 may be implemented on a Compaq DL 360 running Windows 2000 and Domino SMTP Mail Server.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

Other embodiments of the invention will be apparent from consideration of the specification and practice of the invention disclosed herein. It is intended that the specification and examples be considered as exemplary only, with a true scope and spirit of the invention being indicated by the following claims. Indeed, the following claims are each to be considered a separate embodiment of the invention, and are incorporated by reference into this description of embodiments.

What is claimed is:

1. A method of establishing a verifiable random number for use in a process that involves a random number, the method comprising:
selecting a source for a seed number, the source being publicly available and publicly accepted as a source for numbers that are random;
establishing an algorithm that uses the seed number as a basis for determining the verifiable random number;
generating the random number using the seed number and the algorithm; and
publishing the source of the seed number and the algorithm in advance of an existence of the seed number to enable reproduction of a calculation of the random number.

2. The method of claim 1, wherein the process is a game of chance.

3. The method of claim 1, wherein the process is a lottery.

4. The method of claim 1, wherein the source of the seed number is a financial index.

5. The method of claim 4, wherein the financial index includes at least one of the Dow Jones Industrial Average, AMEX, a commodities price, and a futures index.

6. The method of claim 1, wherein the source includes at least one sporting event.

7. The method of claim 1, wherein the seed number is selected by choosing a number from the source.

8. The method of claim 1, wherein the seed number is calculated by assigning numerical values to non-numerical elements generated by the source.

9. The method of claim 1, wherein publishing the source of the seed number and the algorithm further comprises using at least one of e-mail, voice mail, facsimile, mail, an item delivery service, Internet, telephone, diskettes, CD ROM, a kiosk, and an interactive voice response system (IVR).

10. A system of establishing a verifiable random number for use in a process that involves a random number, the system comprising:
an input for receiving a seed number from a predesignated source, the source being publicly available and publicly accepted as a source for numbers that are random;
a processor for receiving the seed number from the input and for incorporating the seed number into a publicly published algorithm, the processor for generating a random number using the seed number and the algorithm; and
a component for publishing the source of the seed number and the algorithm in advance of an existence of the seed number to enable reproduction of a calculation of the random number.

11. The system of claim 10, wherein the process is a game of chance.

12. The system of claim 10, wherein the process is a lottery.

13. The system of claim 10, wherein the source of the seed number is a financial index.

14. The system of claim 13, wherein the financial index includes at least one of the Dow Jones Industrial Average, AMEX, a commodities price, and a futures index.

15. The system of claim 10, wherein the source includes at least one sporting event.

16. The system of claim 10, wherein the seed number is selected by choosing a number from the source.

17. The system of claim 10, wherein the seed number is calculated by assigning numerical values to non-numerical elements generated by the source.

18. The system of claim 10, wherein the component for publishing the source of the seed number and the algorithm is further configured for using at least one of email, voice mail, facsimile, mail, an item delivery service, Internet, telephone, diskettes, CD ROM, a kiosk, and an interactive voice response system (IVR).

19. A lottery method comprising:
publishing, in advance of a lottery, a source for a seed number, the source being publicly available and publicly accepted as a source for numbers that are random;
publishing in advance of the lottery, an algorithm for calculating at least one winning number using the algorithm and the seed number;
calculating at least one winning lottery number using the seed number and the algorithm, wherein the prepublication of the seed source and the algorithm enables lottery participants to independently verify a random nature of a winning lottery number.

20. The method of claim 19, further comprising receiving a wager from at least one lottery participant prior to the establishment of the seed number.

21. The method of claim 20, wherein receiving the wager from the at least one lottery participant further comprises at least one of billing the participant, debiting the participant's checking account, debiting the participant's credit card account, debiting the participant's debit card account, debiting the participant's preestablished account, and receiving cash from the participant.

22. The method of claim 20, wherein receiving the wager from the at least one lottery participant further comprises using at least one of e-mail, voice mail, facsimile, mail, an item delivery service, Internet, telephone, diskettes, CD ROM, a kiosk, and an interactive voice response system (IVR).

23. The method of claim 19, wherein the seed number comprises at least one of the Dow Jones Industrial Average, AMEX, a commodities price, and a futures index.

24. The method of claim 23, wherein the seed number is a value at the end of a full day of trading on a prepublished date of a lottery drawing.

25. The method of claim 19, wherein the seed number is numeric, wherein calculating comprises a division of the seed number by a first value, and wherein at least a portion of the winning number is derived from a remainder of the division.

26. The method of claim 19, wherein the seed number comprises a number including at least two digits, and wherein calculating further comprises:
dividing the seed number by a first value wherein a first sub random element comprises a first division remainder;
rotating a digit at one end of the seed number to an opposite end of the seed number; and
dividing the seed number by the first value, wherein a second sub random element comprises a second division remainder, the winning number being derived from a combination of the first sub random element and the second sub random element.

27. The method of claim 26, wherein when the second sub random element is equal to the first sub random element, and wherein calculating further comprises:
dropping a digit from the seed number; and
dividing the seed number by the first value, wherein the second sub random element comprises the remainder of the division, the winning number being derived from a combination of the first sub random element and the second sub random element.

28. The method of claim 19, wherein the seed number is numeric and wherein the algorithm further comprises a division of the seed number by a first value, wherein at least a portion of the winning number is derived from a remainder of the division.

29. The method of claim 27, wherein the seed number comprises at least two digits, and wherein the algorithm further comprises:
dividing the seed number by a first value, wherein a first sub random element comprises a first division remainder;
rotating a digit at one end of the seed number to an opposite end of the seed number; and
dividing the seed number by the first value, wherein a second sub random element comprises a second division remainder, the winning number being derived from a combination of the first sub random element and the second sub random element.
